(19) United States
(12) Patent Application Publication
(10) Pub. No.: US 2025/0198303 A1
(43) Pub. Date: Jun. 19, 2025

(54) Cryogenic Expansion Turbine with Magnetic Bearings

(71) Applicant: Chart Energy & Chemicals, Inc., Ball Ground, GA (US)

(72) Inventors: Martin Knoche, Oberstammheim (CH); Tadeh Avetian, Burbank, CA (US)

(21) Appl. No.: 18/856,526

(22) PCT Filed: Apr. 11, 2023
(86) PCT No.: PCT/US2023/065617

§ 371 Date: Oct. 11, 2024

Related U.S. Application Data
(60) Provisional application No. 63/330,005, filed on Apr. 12, 2022.

(51) Int. Cl. F01D 25/12; F01D 25/16; F16C 32/04; F16C 37/00; F25J 3/04

(52) U.S. Cl. CPC F01D 25/125; F01D 25/16; F16C 32/0438; F16C 32/0489; F16C 37/005; F25J 3/04781; F05D 2240/515; F16C 2300/52; F25J 2240/02

(57) ABSTRACT

A cryogenic expansion turbine system (10) includes a turbo-expander (12) configured to receive and expand a cryogenic gas feed stream (24). A rotary shaft (16) operatively connects the turbo-expander and a resistance device, such as a compressor (14) or brake. A bearing housing (18) has a bearing cooling fluid inlet port and a bearing cooling fluid outlet port. Electro-magnetic bearings (22) are positioned within the bearing housing and rotatably support the rotary shaft. A bearing cooling circuit (72) directs a stream of bearing cooling fluid (62) into the bearing housing via the bearing cooling fluid inlet port so that the electro-magnetic bearings are cooled and resulting warmed bearing cooling fluid (68) exits the bearing housing via the cooling fluid outlet port.

### CLAIM OF PRIORITY

This application claims the benefit of U.S. Provisional Application No. 63/330,005, filed Apr. 12, 2022, the contents of which are hereby incorporated by reference.

### FIELD OF THE DISCLOSURE

The present disclosure relates generally to cryogenic fluid expansion devices and, more particularly, to a cryogenic expansion turbine with magnetic bearings that provides cooling of the bearings.

### BACKGROUND

Turbine expansion devices or turbo-expanders are used to expand, and thus provide refrigeration of, cryogenic gases in industrial processes such as liquefaction of hydrogen or natural gas. The work performed by the cryogenic gas in turning the expander wheel of the turbo-expander cools the gas in the expander. The centrifugal or axial flow of the cryogenic gas through the turbine as it expands is often used to drive a compressor, generator or other brake so that work is extracted from the expanding gas. Partial liquefaction of the expanded gas may occur.

When the turbo-expander is used to drive a compressor or generator, an expander wheel is typically positioned on one end of a rotary shaft and a compressor wheel or generator is positioned on the opposite end of the rotary shaft. The rotary shaft operates at a very high rotary speed (typically 25,000 revolutions per minute or more) and thus must be supported by suitable bearings.

Magnetic bearings have been used in cryogenic turbo-expanders as they support the rotary shafts within a bearing housing without physical contact. As a result, the bearings have low friction and do not suffer from wear or speed restrictions. Most magnetic bearings are active magnetic bearings and thus use electromagnets, which require continuous electrical power. As a result, heat builds up in the electrical coils of the electromagnets, and thus the bearing housing, so that cooling is desirable.

Furthermore, a seal surrounding the rotary shaft must be positioned between the bearing housing and the turbo-expander as the bearings operate at a temperature well above that of the cryogenic turbo-expander, which operates at cryogenic temperatures. As the bearings heat up, pressure may build within the bearing housing forcing gas to leak through the seal and into the turbo-expander. Proper management of bearing temperature is desirable to avoid compromising the seal. A compromised seal could result in contamination of the cold gas within the turbo-expander with leaked warm fluid from the bearings and damage to the bearings by leaked cold fluid from the turbo-expander. While high temperature superconducting (HTS) magnetic bearings take advantage of the temperature of the refrigerating gas to eliminate electrical resistance in the bearing, segregation of the fluids within the HTS magnetic bearing housing and the turbo-expander housing may still be required under some conditions, such as if a compressor brake is driven in steady state conditions by the turbo-expander.

### SUMMARY OF THE DISCLOSURE

There are several aspects of the present subject matter which may be embodied separately or together in the methods, devices and systems described and claimed below. These aspects may be employed alone or in combination with other aspects of the subject matter described herein, and the description of these aspects together is not intended to preclude the use of these aspects separately or the claiming of such aspects separately or in different combinations as set forth in the claims appended hereto.

In one aspect, a cryogenic expansion turbine includes a turbo-expander configured to receive and expand a cryogenic gas feed stream, a resistance device and a rotary shaft operatively connecting the turbo-expander and the resistance device. A bearing housing has a bearing cooling fluid inlet port and a bearing cooling fluid outlet port. A plurality of electro-magnetic bearings is positioned within the bearing housing and rotatably supports the rotary shaft. A bearing cooling circuit directs a stream of bearing cooling fluid into the bearing housing via the bearing cooling fluid inlet port whereby the plurality of electro-magnetic bearings is cooled. Resulting warmed bearing cooling fluid exits the bearing housing via the cooling fluid outlet port.

In another aspect, a method of cooling electro-magnetic bearings in a cryogenic expansion device having a turbo-expander operatively connected to a resistance load by a rotary shaft supported by the electro-magnetic bearings in a bearing housing includes the steps of directing bearing cooling fluid to the bearing housing, cooling the electro-magnetic bearings using the bearing cooling fluid so that warmed bearing cooling fluid is created and withdrawing the warmed bearing cooling fluid from the bearing housing.

In still another aspect, a cryogenic expansion turbine includes a turbo-expander configured to receive and expand a cryogenic gas feed stream, a resistance device and a rotary shaft operatively connecting the turbo-expander and the resistance device. A bearing housing has a bearing cooling fluid inlet port and a bearing cooling fluid outlet port. A plurality of electro-magnetic bearings is positioned within the bearing housing and rotatably supports the rotary shaft. A cooling jacket at least partially surrounds the bearing housing. A bearing cooling circuit is configured to direct a stream of bearing cooling fluid into the cooling jacket whereby the plurality of electro-magnetic bearings is cooled and resulting warmed bearing cooling fluid exits the cooling jacket.

### BRIEF DESCRIPTION OF THE DRAWINGS

FIG. 1 is a schematic illustration of a first embodiment of the cryogenic expansion turbine of the disclosure.

FIG. 2 is a schematic illustration of a second embodiment of the cryogenic expansion turbine of the disclosure.

FIG. 3 is a schematic illustration of a third embodiment of the cryogenic expansion turbine of the disclosure.

FIG. 4 is a schematic illustration of a fourth embodiment of the cryogenic expansion turbine of the disclosure.

FIG. 5 is a schematic illustration of a fifth embodiment of the cryogenic expansion turbine of the disclosure.

FIG. 6 is a schematic illustration of a sixth embodiment of the cryogenic expansion turbine of the disclosure.

### DETAILED DESCRIPTION OF EMBODIMENTS

A more detailed description of the system and method in accordance with the present disclosure is set forth below. It should be understood that the description below of specific systems and methods is intended to be exemplary, and not exhaustive of all possible variations or applications. Thus, the scope of the disclosure is not intended to be limiting and should be understood to encompass variations or embodiments that would occur to persons of ordinary skill.

It should be noted herein that the lines, conduits, piping, passages and similar structures and the corresponding streams are sometimes both referred to by the same element number set out in the figures.

Reference numerals that are introduced in the specification in association with a drawing figure may be repeated in one or more subsequent figures for shared elements or components without additional description in the specification in order to provide context for other features.

In the claims, letters are used to identify claimed steps (e.g. a., b. and c.). These letters are used to aid in referring to the method steps and are not intended to indicate the order in which the claimed steps are performed, unless and only to the extent that such order is specifically recited in the claims.

While the embodiments described below reference hydrogen gas as the cryogenic gas feed stream being expanded in the turbo-expander, the technology of the disclosure may be used to expand other cryogenic fluids. In addition, while hydrogen is used as the recirculation and bearing cooling fluids in the embodiments described below, alternative fluids known in the art may be used.

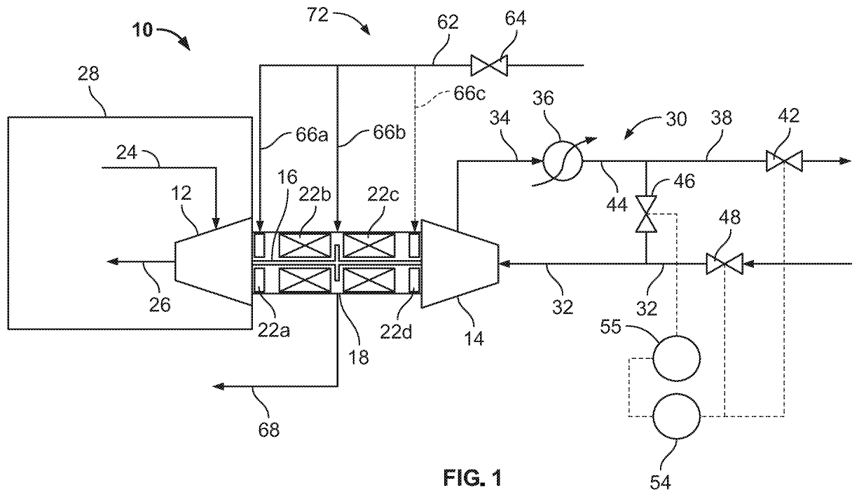

A first embodiment of the cryogenic expansion turbine of the disclosure is indicated in general at 10 in FIG. 1. The cryogenic expansion turbine 10 includes a turbo-expander 12 and a resistance device, which in this embodiment is a compressor 14, connected by a rotary shaft 16. The rotary shaft 16 is rotatably mounted within a bearing housing 18 by active or electro-magnetic bearings 22a-22d. As is known in the art, seals are provided around the rotating rotary shaft at the two locations where the shaft exits the bearing housing 18. Suitable active or electro-magnetic bearings may be obtained from the SKF Group of Gothenburg, Sweden, or Waukesha Bearings of Waukesha, Wisconsin in the USA. Examples of suitable active magnetic bearings are presented in U.S. Pat. No. 4,652,780 to Murakami et al., U.S. Pat. No. 4,720,649 to Habermann et al., U.S. Pat. No. 9,845,829 to Hay et al. and U.S. Pat No. 10,030,703 to Bauce et al., the contents of each of which are hereby incorporated by reference. Examples of suitable high temperature superconducting (HTS) magnetic bearings, for embodiments described below, are disclosed in European Patent Application No. EP1835188 to Nexans and U.S. Patent No. 5,789,837 to Shin et al., the contents of each of which are hereby incorporated by reference.

As is known in the art, the turbo-expander 12 contains an inlet, an outlet and an expander wheel so that gas entering the turbo-expander is expanded with the resulting cooled fluid exiting the turbo-expander. The compressor 14 contains an inlet, and outlet and a compressor wheel that is turned by the turning expander wheel via the rotary shaft 16 so that the turbo-expander 12 and the compressor 14 are operatively connected by the rotary shaft 16.

A hydrogen cryogenic gas feed stream 24 enters the turbo-expander 14 and is expanded as it performs work. The resulting cooled hydrogen fluid feed stream exits as stream 26. The turbo-expander may be positioned within a cold box 28 with the cooled hydrogen fluid stream proceeding to a liquefaction process.

The compressor 14 is provided with a recirculation fluid circuit, indicated in general at 30 in FIG. 1. A hydrogen gas recirculation stream 32 enters the compressor 14 and is compressed. As a result, the turbo-expander 12 performs work in turning the compressor 14. The resulting warmed recirculation stream exits the compressor as stream 34 and is cooled in aftercooler 36. As examples only, the aftercooler may be a heat exchanger using ambient air or a refrigerant as the cooling stream. The recirculation fluid circuit includes a recirculation fluid removal line 38 having a corresponding removal valve 42. When removal valve 42 is open, cooled fluid 44 from the aftercooler 36 may be directed out of the recirculation fluid circuit through line 38. Alternatively, when valve 42 is closed, which is the normal mode of operation, fluid 44 is directed through expansion valve 46 to provide flow pressure resistance so that the turbo-expander 12 is forced to do work in turning the compressor 14. As a result, expanded and cooled stream 32 is formed (when supply valve 48 is closed).

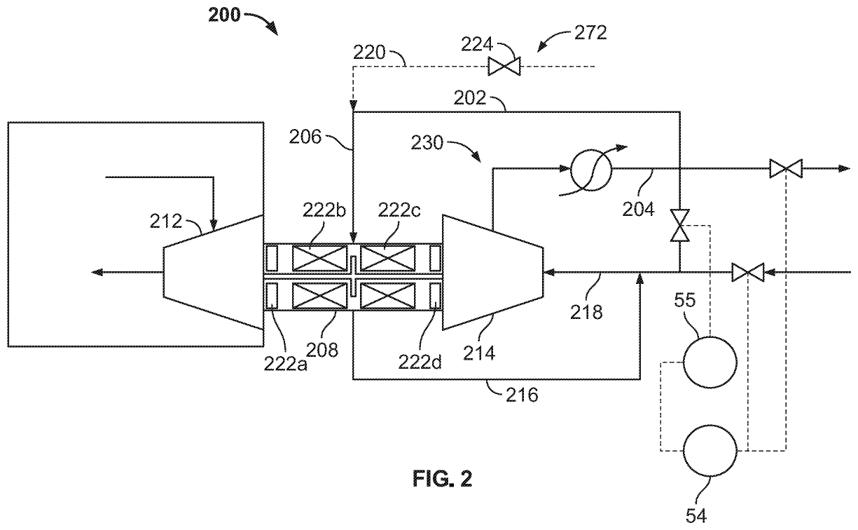

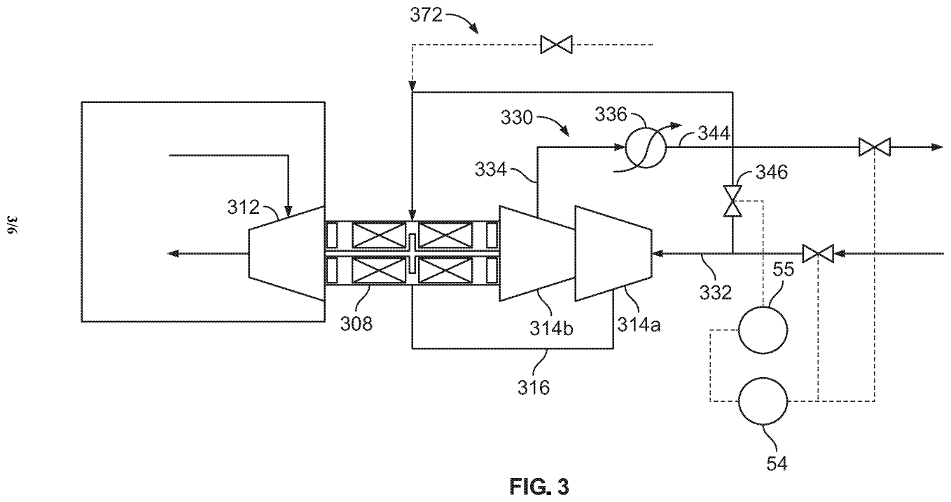

Additional hydrogen recirculation fluid may be provided to the recirculation circuit via a supply line 52 when supply valve 48 is opened. As noted previously, removal valve 42 may be opened to remove fluid from the recirculation fluid circuit 30. Supply valve 48 and removal valve 42 may be automated and provided with feedback control via a pressure controller 54 so that the proper amount of fluid may be maintained within the recirculation circuit. A speed controller 55 may also be provided for the expansion valve 46, which may also be automated. As an example only, the speed controller may be an outer loop that feeds the pressure controller (i.e. cascade control scheme). A similar valve control scheme may be used in the systems of FIG. 2 and FIG. 3 described below.

The system of FIG. 1 is provided with a bearing cooling circuit, indicated in general at 72. A bearing cooling fluid, such as hydrogen gas, from a pressurized source is in fluid communication with a cooling fluid line 62 of the bearing circuit, which is provided with a control valve 64. As an example only, the cooling fluid may be pressurized to approximately 20 psi above pressure at the outer diameter of the expander wheel of the turbo-expander 12. When control valve 64 is open, hydrogen cooling gas is provided to the interior of the bearing housing via cooling fluid inlet ports as indicated by arrows 66a, 66b and 66c. While three cooling fluid inlet ports are illustrated in FIG. 1, the housing may alternatively only have one inlet port or more than three inlet ports. The coils of the active magnetic bearings 22a-22d are cooled by the hydrogen gas cooling fluid, and the warmed cooling fluid exits the bearing housing 18 via a cooling fluid outlet port and line of the bearing cooling circuit, as represented by arrow 68. While one cooling fluid outlet port is illustrated in FIG. 1, the housing may alternatively have more than one outlet port.

The warmed hydrogen gas cooling fluid 68 exiting the bearing housing 18 may be directed to a liquefaction system compressor or other destination. As a result, the system of FIG. 1 features an open loop bearing cooling circuit.

A second embodiment of the system of the disclosure is indicated in general at 200 in FIG. 2 and includes a closed loop bearing cooling circuit 272. The configuration and operation of the system 200 of FIG. 2 is the same as FIG. 1 with the exception of the configuration of the bearing cooling circuit.

In the system of FIG. 2, a cooling fluid line 202 branches off of line 204 of the recirculation fluid circuit, indicated in general at 230. As a result, a portion of the hydrogen in the recirculation circuit flows through line 202 and into the interior of the bearing housing 208 via a cooling fluid inlet port as indicated by arrow 206. While one cooling fluid inlet port is illustrated in FIG. 2, the housing may alternatively have more than one inlet port. The coils of the active magnetic bearings 222a-222d are cooled by the hydrogen gas cooling fluid, and the warmed cooling fluid exits the bearing housing 208 via a cooling fluid outlet port and line 216. While one cooling fluid outlet port is illustrated in FIG. 2, the housing may alternatively have more than one outlet port.

The warmed hydrogen gas cooling fluid in line 216 exiting the bearing housing 208 travels back to the recirculation fluid circuit and enters the circuit by joining line 218. As a result, the system of FIG. 2 features a closed loop bearing cooling circuit.

A cooling fluid supply line 220 is provided with a valve 224 and communicates with a pressurized supply of hydrogen gas. As a result, the cooling fluid circuit and the recirculation fluid circuit may be replenished with hydrogen gas if necessary when valve 224 is opened.

The embodiment of FIG. 2 offers the advantages of typically not requiring the addition of removal of hydrogen to the bearing cooling fluid circuit and the efficiency provided by the compressor 214 (as powered by turbo-expander 212) providing the cooling flow of hydrogen gas to the bearings.

With the exception of the components described above, the remaining portion of the system of FIG. 2 features the same structure and functionality as the previous embodiment.

If added braking is required for the system of FIG. 2 so that the turbo-expander performs additional work, or added compression for the recirculation and braking fluid circuits is required, an additional resistance device in the form of a second compressor may be added to the system of FIG. 2, as illustrated in FIG. 3. More specifically, with reference to FIG. 3, the recirculation fluid circuit, indicated in general at 330, may include first and second compressor stages 314a and 314b. The first and second compressor stages 314a and 314b are both powered by the turbo-expander 312 and may be separate compressors or separate stages of a single compressor.

As illustrated in FIG. 3, the warmed cooling fluid exits the bearing housing 308 via a cooling fluid outlet port and line 316 of the bearing cooling circuit 372 and is directed to an inlet of the first compressor stage 314a. In addition, stream 332, which is formed when cooled fluid 344 from the aftercooler 336 is directed through expansion valve 346 as in previous embodiments, is directed into the first compressor stage 314a. A warmed recirculation stream exits the second compressor stage 314b as stream 334 and is cooled in aftercooler 336.

With the exception of the components described above, the remaining portion of the system of FIG. 3 features the same structure and functionality as the previous embodiments.

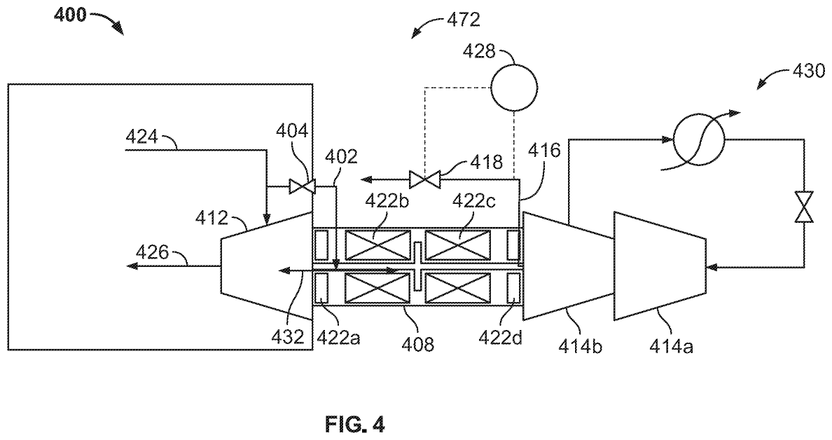

A fourth embodiment of the system of the disclosure is indicated in general at 400 in FIG. 4. In this embodiment, high temperature superconducting (HTS) magnets are used in the HTS magnetic bearings 422a-422d. An HTS magnetic bearing also requires cooling to compensate for heat losses, but without electrical resistance, no heat will be generated when the magnets are operated. The system of FIG. 4 includes a bearing cooling circuit 472 wherein a cooling fluid line 402 branches off of the hydrogen cryogenic gas feed line 424 that enters the turbo-expander 414. As a result, when inlet control valve 404 is open, a portion of the hydrogen gas feed stream from line 424 flows through bearing cooling fluid inlet line 402 and into the interior of the bearing housing 408 via a cooling fluid inlet port. As an example only, the hydrogen gas in line 402 may be approximately 60° K. While one cooling fluid inlet port is illustrated in FIG. 4, the housing may alternatively have more than one inlet port. The HTS magnetic bearings 422a-422d are cooled by the hydrogen gas cooling fluid so that the superconducting material is cooled to the necessary cryogenic temperature (such as <70° K) whereby resistance, and thereby heat generation due to electrical current, is avoided or minimized. The warmed cooling fluid exits the bearing housing 408 via a cooling fluid outlet port and bearing cooling fluid outlet line 416 under the control of outlet control valve 418, and may be returned to the main system compressor included within the circuit through which the hydrogen gas feed stream within line 424 flows. In some alternative embodiments, the expander gas may exit through the compression circuit. While one cooling fluid outlet port is illustrated in FIG. 4, the housing may alternatively have more than one outlet port.

The warmed hydrogen gas cooling fluid exiting the bearing housing 408 through line 416 and valve 418 may be directed to a liquefaction system compressor or other destination. Valve 418 may be automated and provided with feedback control including temperature controller 428 to properly regulate the flow of fluid through line 416 to ensure sufficient cooling of the high temperature superconducting magnetic bearings 422a-422d.

As indicated at 432 in FIG. 4, a portion of the hydrogen gas introduced into the bearing housing 408 may be returned to the turbo-expander 412 where it joins the stream 426 exiting the turbo-expander 412 after expansion and cooling.

As in the embodiment of FIG. 3, the system of FIG. 4 includes a recirculation fluid circuit, which may be a closed loop cycle, indicated in general at 430, that includes two compressor stages 414a and 414b to provide work for sufficient cooling within the turbo-expander 412. In some alternative embodiments, one compressor alone may be sufficient.

With the exception of the components described above, the remaining portion of the system of FIG. 4 features the same structure and functionality as the previous embodiments.

Magnetic fields can be much stronger with the HTS magnetic bearings of the embodiment of FIG. 4 than with conventional magnetic bearings. In addition, motors and generators (relevant to embodiments described below) based on HTS may be reduced to ⅓ of the original size. With a stronger magnetic field and smaller size, higher rpm and higher efficiencies can be reached. Similar would apply for an HTS generator brake.

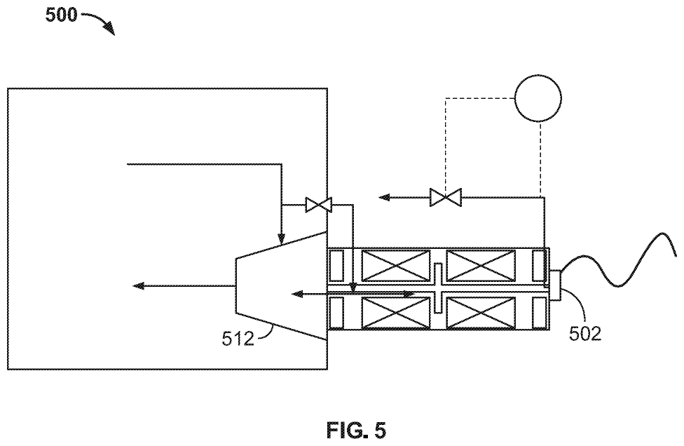

A fifth embodiment of the system of the disclosure is indicated in general at 500 in FIG. 5 and substitutes a generator/eddy current brake 502 for the compressors 414a and 414b of FIG. 4 as the resistance device for the turbo-expander 512. Such a generator may optionally be provided as an HTS generator, as cryogenic gas is already in the vicinity for use therein. As a result, the generator 502 acts as an eddy current brake. The remaining portion of the system of FIG. 5 features the same structure and functionality as the system of FIG. 4.

It should be understood that the generator/eddy current brake 502 of FIG. 5 could be substituted for any of the compressors of FIGS. 1-4 as the resistance device. In addition, any of the compressors of FIGS. 1-4 could be supplemented by the generator/eddy current brake 502 of FIG. 5 so that the rotary shaft turned by the turbo-expander in each embodiment turns both the compressor(s) and the generator/eddy current brake as the resistance devices.

In a sixth embodiment of the system of the disclosure, a cooling jacket 606 at least partially surrounds the bearing housing 608 as a substitute for directing cooling gas into the bearing housing to cool the magnetic bearings. As indicated by arrow 605, the cooling jacket features an inlet port and receives water. As a result, the sidewall(s) of the exterior of the bearing housing 608 is/are surrounded by cooling water to provide cooling for the bearings 622a-622d inside. As indicated by arrow 607, the jacket features an outlet port through which warmed water or evaporated gas exits the jacket as cooler water enters through the inlet port at 605. As a result, the cooling water circulates through the jacket. In embodiments where bearings 622a-622d are HTS magnetic bearings, the sidewall(s) of the exterior of the bearing housing 608 may be surrounded by liquid nitrogen to provide cooling for the bearings inside.

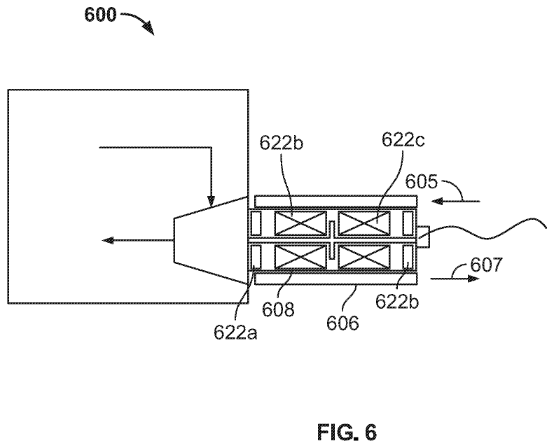

The remaining portion of the system of FIG. 6 features the same structure and functionality as the system of FIG. 5.

While the preferred embodiments of the disclosure have been shown and described, it will be apparent to those skilled in the art that changes and modifications may be made therein without departing from the spirit of the disclosure, the scope of which is defined by the following claims.

What is claimed is:

1. A cryogenic expansion turbine comprising:
a. a turbo-expander configured to receive and expand a cryogenic gas feed stream;
b. a resistance device;
c. a rotary shaft operatively connecting the turbo-expander and the resistance device;
d. a bearing housing have a bearing cooling fluid inlet port and a bearing cooling fluid outlet port;
e. a plurality of electro-magnetic bearings positioned within the bearing housing and rotatably supporting the rotary shaft;
f. a bearing cooling circuit configured to direct a stream of bearing cooling fluid into the bearing housing via the bearing cooling fluid inlet port whereby the plurality of electro-magnetic bearings is cooled and resulting warmed bearing cooling fluid exits the bearing housing via the cooling fluid outlet port.

2. The cryogenic expansion turbine of claim 1 wherein the resistance device includes a compressor.

3. The cryogenic expansion turbine of claim 2 further comprising a recirculation fluid circuit including an aftercooler configured to receive compressed fluid from the compressor, an expansion valve configured to receive cooled fluid from the aftercooler and to direct expanded fluid to the compressor.

4. The cryogenic expansion turbine of claim 3 wherein the recirculation fluid circuit further includes a recirculation fluid removal line having a removal valve configured so that recirculation fluid is removed from the recirculation fluid circuit when the removal valve is opened and a recirculation fluid supply line having a supply valve configured so that recirculation fluid is added to the recirculation fluid circuit when the supply valve is opened.

5. The cryogenic expansion turbine of claim 3 further comprising a hydrogen recirculation fluid.

6. The cryogenic expansion turbine of claim 3 wherein the bearing cooling circuit is configured to receive bearing cooling fluid from the recirculation fluid circuit and to return bearing cooling fluid from the recirculation fluid circuit.

7. The cryogenic expansion turbine of claim 6 wherein the bearing recirculation circuit provides bearing cooling fluid downstream of the aftercooler and returns bearing cooling fluid to the recirculation downstream of the expansion valve.

8. The cryogenic expansion turbine of claim 6 further comprising hydrogen recirculation fluid and hydrogen bearing cooling fluid.

9. The cryogenic expansion turbine of claim 6 wherein the bearing cooling circuit further comprises a bearing cooling fluid supply line and a bearing cooling fluid supply valve configured to provide bearing cooling fluid to the bearing cooling circuit when opened.

10. The cryogenic expansion turbine of claim 6 wherein the resistance device includes a first compressor stage and a second compressor stage wherein the aftercooler configured to receive compressed fluid from the second compressor stage and the expansion valve is configured to direct expanded fluid to the first compressor.

11. The cryogenic expression turbine of claim 10 wherein the first and second compressor stages are first and second stages of a single compressor.

12. The cryogenic expansion turbine of claim 10 wherein the first compressor stage includes a first compressor and the second compressor stage includes a second compressor.

13. The cryogenic expansion turbine of claim 2 wherein the resistance device includes a first compressor stage and a second compressor stage.

14. The cryogenic expression turbine of claim 13 wherein the first and second compressor stages are first and second stages of a single compressor.

15. The cryogenic expansion turbine of claim 13 wherein the first compressor stage includes a first compressor and the second compressor stage includes a second compressor.

16. The cryogenic expansion turbine of claim 1 further comprising a gas feed line configured to deliver a cryogenic gas feed stream to the turbo-expander and wherein the bearing cooling circuit includes:
g. a bearing cooling fluid inlet line that is configured to receive bearing cooling fluid from the gas feed line and direct bearing cooling fluid to the bearing cooling fluid inlet port;
h a bearing cooling fluid outlet line that is configured to receive warmed bearing cooling fluid from the bearing cooling fluid outlet port of the bearing housing.

17. The cryogenic expansion turbine of claim 16 wherein the bearing cooling fluid inlet line includes an inlet control valve and the bearing cooling fluid outlet line includes an outlet control valve.

18. The cryogenic expansion turbine of claim 16 further comprising a hydrogen cryogenic feed gas and a hydrogen bearing cooling fluid.

19. The cryogenic expansion turbine of claim 16 wherein the resistance device includes a first compressor stage and a second compressor stage and further comprising a recirculation fluid circuit including an aftercooler configured to receive compressed fluid from the second compressor stage, an expansion valve configured to receive cooled fluid from the aftercooler and to direct expanded fluid to the first compressor stage.

20. The cryogenic expansion turbine of claim 16 wherein the resistance device includes an eddy current brake.

21. The cryogenic expansion turbine of claim 1 further comprising a hydrogen bearing cooling fluid.

22. The cryogenic expansion turbine of claim 1 wherein the resistance device includes an eddy current brake.

23. The cryogenic expansion turbine of claim 1 wherein the resistance device includes a compressor and an eddy current brake.

24. The cryogenic expansion turbine of claim 1 wherein the plurality of electro-magnetic bearings are high temperature superconducting magnetic bearings.

25. A method of cooling electro-magnetic bearings in a cryogenic expansion device having a turbo-expander operatively connected to a resistance load by a rotary shaft supported by the electro-magnetic bearings in a bearing housing including the steps of:
a. directing bearing cooling fluid to the bearing housing;
b. cooling the electro-magnetic bearings using the bearing cooling fluid so that warmed bearing cooling fluid is created;
c. withdrawing the warmed bearing cooling fluid from the bearing housing.

26. The method of claim 25 wherein the bearing cooling fluid includes hydrogen gas.

27. The method of claim 26 wherein the bearing cooling fluid includes hydrogen gas at approximately 60° K.

28. The method of claim 25 wherein the resistance load includes a compressor and further comprising the step of compressing a recirculation fluid using the compressor and wherein step a. includes directing a portion of the recirculation fluid to the bearing housing as the bearing cooling fluid.

29. The method of claim 28 wherein the recirculation fluid and the bearing cooling fluid include hydrogen gas.

30. The method of claim 25 further comprising the step of directing a cryogenic gas feed stream to the turbo-expander and wherein step a. includes directing a portion of the cryogenic gas feed stream to the bearing housing as the bearing cooling fluid.

31. The method of claim 30 wherein the cryogenic gas feed stream and the bearing cooling fluid includes hydrogen gas.

32. The method of claim 25 wherein the plurality of electro-magnetic bearings are high temperature superconducting magnetic bearings.

33. A cryogenic expansion turbine comprising:
a. a turbo-expander configured to receive and expand a cryogenic gas feed stream;
b. a resistance device;
c. a rotary shaft operatively connecting the turbo-expander and the resistance device;
d. a bearing housing have a bearing cooling fluid inlet port and a bearing cooling fluid outlet port;
e. a plurality of electro-magnetic bearings positioned within the bearing housing and rotatably supporting the rotary shaft;
f. a cooling jacket at least partially surrounding the bearing housing;
g. a bearing cooling circuit configured to direct a stream of bearing cooling fluid into the cooling jacket whereby the plurality of electro-magnetic bearings is cooled and resulting warmed bearing cooling fluid exits the cooling jacket.

34. The cryogenic expansion turbine of claim 32 further comprising water as the bearing cooling fluid.

35. The cryogenic expansion turbine of claim 32 wherein the resistance device includes an eddy current brake.

36. The cryogenic expansion turbine of claim 32 wherein the resistance device includes a compressor.

37. The cryogenic expansion turbine of claim 33 wherein the plurality of electro-magnetic bearings are high temperature superconducting magnetic bearings.

38. The cryogenic expansion turbine of claim 37 further comprising nitrogen as the bearing cooling fluid.
